(19) United States
(12) Patent Application Publication
(10) Pub. No.: US 2022/0404192 A1
(43) Pub. Date: Dec. 22, 2022

(54) Dynamic Human-Machine Interface and Control Mechanism for Culinary Instrument

(71) Applicant: Creator, Inc., San Francisco, CA (US)

(72) Inventors: David BORDOW, San Francisco, CA (US); Jeff C. JENSEN, San Francisco, CA (US); Paul RADCLIFFE, San Francisco, CA (US); James RILEY, San Francisco, CA (US); Natalie PAN, San Francisco, CA (US); Steven FREHN, San Francisco, CA (US); Alexandros VARDAKOSTAS, San Francisco, CA (US)

(21) Appl. No.: 17/896,660

(22) Filed: Aug. 26, 2022

Related U.S. Application Data
(63) Continuation of application No. PCT/US2021/021585, filed on Mar. 9, 2021.
(60) Provisional application No. 62/987,319, filed on Mar. 9, 2020.

(51) Int. Cl. G01G 19/38; G01G 19/34; G01G 19/40

(52) U.S. Cl. CPC G01G 19/38; G01G 19/346; G01G 19/40

(57) ABSTRACT

A system for controlling a culinary instrument includes a component data structure storing, for at least some culinary components, a culinary attribute. A menu data structure stores, for each of multiple items, a set of constituent components. An order interface module receives an item selection by a user and a set of adjustments to the selected item. Each element of the set describes an amount modification of a corresponding culinary component. An order feedback module uses a first set of rules to assess the set of adjustments based on the corresponding culinary attributes. In response to the assessment, the order feedback module selectively provides feedback to the user regarding limitations on the set of adjustments. A control transformation module uses a second set of rules to transform the adjusted selected item into a set of instrument control instructions for control of the culinary instrument, which autonomously performs the instructions.

### CROSS-REFERENCE TO RELATED APPLICATIONS

This application is a continuation of International Application No. PCT/US2021/021585 filed Mar. 9, 2021, which claims the benefit of U.S. Provisional Application No. 62/987,319 filed Mar. 9, 2020, the entire disclosures of which are incorporated by reference.

### FIELD

The present disclosure relates generally to the field of on-demand food preparation, and more specifically to a human-machine interface and control mechanism for an automated culinary instrument.

### SUMMARY

A system for controlling a culinary instrument includes a component data structure storing, for at least some of a plurality of culinary components, a culinary attribute. The system includes a menu data structure storing, for each of a plurality of items, a set of constituent components. The system includes an order interface module configured to receive (i) a selection of a selected item of the plurality of items by a user and (ii) a set of adjustments to the selected item specified by the user. Each element of the set of adjustments describes a modification of an amount of a corresponding one of the plurality of culinary components. The system includes an order feedback module configured to according to a first set of rules, assess the set of adjustments based on the culinary attributes of the corresponding ones of the plurality of culinary components; and, in response to the assessment, selectively provide feedback to the user regarding limitations on the set of adjustments. The system includes a control transformation module configured to, in response to user approval of the selected item, use a second set of rules to transform the selected item and the set of adjustments into a set of instrument control instructions. The set of instrument control instructions dictate specific amounts of the corresponding ones of the plurality of culinary components. The culinary instrument autonomously performs the set of instrument control instructions to craft the selected item for the user.

In other features, the system includes a communication module configured to transmit the instrument control instructions to the culinary instrument over a communications network. In other features, the order interface module and the order feedback module are implemented on a mobile device of the user. In other features, the culinary attribute is sodium level. In other features, the first set of rules includes a total sodium limit. In other features, the order feedback module is configured to, in response to the assessment indicating that the set of adjustments exceeds the total sodium limit, provide feedback to the user indicating a sodium concern and recommending a decrease in the set of adjustments.

In other features, the order feedback module is configured to, in response to the assessment indicating that the set of adjustments exceeds the total sodium limit, reduce an amount of at least one of the set of adjustments. In other features, the order feedback module is configured to, in response to the assessment indicating that the set of adjustments exceeds the total sodium limit, proportionally reduce an amount of all of the set of adjustments whose corresponding sodium level is above a threshold. In other features, the first set of rules includes a plurality of total sodium limits corresponding respectively to a plurality of food order types.

In other features, the plurality of food order types includes a hamburger type and a bowl type. In other features, the first set of rules includes a limit on number of culinary components of a first type. In other features, the first type is one of a liquid sauce and a dry seasoning. In other features, the limit is determined based on a takt time of the culinary instrument. In other features, the component data structure stores, for at least some of the plurality of culinary components, a cost attribute. In other features, the first set of rules includes a cost limit. In other features, the first set of rules includes an upper limit on thickness-increasing culinary components.

In other features, the upper limit is based on a vertical spacing between a dispensing subsystem of the culinary instrument and a conveyance subsystem of the culinary instrument. In other features, the order feedback module is configured to, in response to the assessment, selectively modify the set of adjustments to the selected item until the first set of rules is satisfied. In other features, the feedback comprises placing a restriction on extent of adjustment of user interface controls. In other features, the restriction includes preventing a slider control from moving to an end of its range. In other features, the feedback includes visually deemphasizing unavailable options. In other features, the unavailable options include currently unselected ones of the plurality of culinary components.

In other features, the first set of rules includes an upper limit on number of unique liquid components. The order feedback module is configured to, in response to the upper limit being reached, visually deemphasize currently unselected liquid components. In other features, the visual deemphasizing includes shifting visual indicators of the unavailable options toward gray. In other features, the visual deemphasizing includes decreasing contrast of visual indicators of the unavailable options with respect to a background. In other features, the first set of rules includes an upper limit on liquid volume. In other features, the first set of rules includes a plurality of upper limits on liquid volume for respective locations of a food item. In other features, the locations include a top surface and a bottom surface. In other features, the locations include an upper bread product of a sandwich and a lower bread product of the sandwich.

In other features, the order feedback module is configured to, in response to any one of the plurality of upper limits being exceeded, redistribute liquid culinary components to other locations. In other features, the control transformation module is configured to determine the specific amounts by quantizing amounts specified by the user into increments dispensable by the culinary instrument. In other features, the second set of rules includes, for at least some of the plurality of culinary components, a minimum dispensed amount. In other features, the control transformation module is configured to specify an order of application of the corresponding ones of the plurality of culinary components. In other features, the control transformation module is configured to specify dispense target areas for the corresponding ones of the plurality of culinary components.

A method of controlling a culinary instrument includes storing, for at least some of a plurality of culinary components, a culinary attribute. The method includes storing, for each of a plurality of items, a set of constituent components. The method includes receiving (i) a selection of a selected item of the plurality of items by a user and (ii) a set of adjustments to the selected item specified by the user. Each element of the set of adjustments describes a modification of an amount of a corresponding one of the plurality of culinary components. The method includes according to a first set of rules, assessing the set of adjustments based on the culinary attributes of the corresponding ones of the plurality of culinary components. The method includes, in response to the assessment, selectively providing feedback to the user regarding limitations on the set of adjustments. The method includes, in response to user approval of the selected item, using a second set of rules to transform the selected item and the set of adjustments into a set of instrument control instructions. The set of instrument control instructions dictate specific amounts of the corresponding ones of the plurality of culinary components. The culinary instrument autonomously performs the set of instrument control instructions to craft the selected item for the user.

In other features, the method includes transmitting the instrument control instructions to the culinary instrument over a communications network. In other features, the culinary attribute is sodium level. In other features, the first set of rules includes a total sodium limit. In other features, the method includes, in response to the assessment indicating that the set of adjustments exceeds the total sodium limit, providing feedback to the user indicating a sodium concern and recommending a decrease in the set of adjustments. In other features, the method includes, in response to the assessment indicating that the set of adjustments exceeds the total sodium limit, reducing an amount of at least one of the set of adjustments.

In other features, the method includes, in response to the assessment indicating that the set of adjustments exceeds the total sodium limit, proportionally reducing an amount of all of the set of adjustments whose corresponding sodium level is above a threshold. In other features, the first set of rules includes a plurality of total sodium limits corresponding respectively to a plurality of food order types. In other features, the plurality of food order types includes a hamburger type and a bowl type. In other features, the first set of rules includes a limit on number of culinary components of a first type. In other features, the first type is one of a liquid sauce and a dry seasoning.

In other features, the limit is determined based on a takt time of the culinary instrument. In other features, the method includes storing, for at least some of the plurality of culinary components, a cost attribute. In other features, the first set of rules includes a cost limit. In other features, the first set of rules includes an upper limit on thickness-increasing culinary components. In other features, the upper limit is based on a vertical spacing between a dispensing subsystem of the culinary instrument and a conveyance subsystem of the culinary instrument. In other features, the method includes, in response to the assessment, selectively modifying the set of adjustments to the selected item until the first set of rules is satisfied.

In other features, the feedback comprises placing a restriction on extent of adjustment of user interface controls. In other features, the restriction includes preventing a slider control from moving to an end of its range. In other features, the feedback includes visually deemphasizing unavailable options. In other features, the unavailable options include currently unselected ones of the plurality of culinary components. In other features, the first set of rules includes an upper limit on number of unique liquid components. The method includes, in response to the upper limit being reached, visually deemphasizing currently unselected liquid components.

In other features, the visual deemphasizing includes shifting visual indicators of the unavailable options toward gray. In other features, the visual deemphasizing includes decreasing contrast of visual indicators of the unavailable options with respect to a background. In other features, the first set of rules includes an upper limit on liquid volume. In other features, the first set of rules includes a plurality of upper limits on liquid volume for respective locations of a food item. In other features, the locations include a top surface and a bottom surface. In other features, the locations include an upper bread product of a sandwich and a lower bread product of the sandwich.

In other features, the method includes, in response to any one of the plurality of upper limits being exceeded, redistributing liquid culinary components to other locations. In other features, the specific amounts are determined by quantizing amounts specified by the user into increments dispensable by the culinary instrument. In other features, the second set of rules includes, for at least some of the plurality of culinary components, a minimum dispensed amount. In other features, the method includes specifying an order of application of the corresponding ones of the plurality of culinary components. In other features, the method includes specifying dispense target areas for the corresponding ones of the plurality of culinary components.

A system for constructing a food order includes a menu database including a set of culinary components and, for each food machine of a set of food machines, a corresponding subset of food machine culinary components. The system includes a rules framework database including, for each culinary component of the set of culinary components, a corresponding set of component rules; for each food order type of a set of food order types, a corresponding set of order type rules; and a set of rebalancing rules. The system includes an order selection and display module configured to obtain the set of culinary components from the menu database; display the set of culinary components on a graphical user interface of a user device; receive a selected culinary component of the set of culinary components from the user device; and, in response to receiving the selected culinary component, add the selected culinary component to a food order. The food order includes a set of selected culinary components. The system includes a rebalancing module configured to in response to receiving the food order from the order selection and display module, identify a violation of at least one of (i) an component rule of the set of component rules and (ii) an order type rule of the set of order type rules. The rebalancing module is configured to, in response identifying the violation, adjust at least one of (i) and amount and (ii) a location of a subset of selected culinary components based on a corresponding rebalancing rule of the set of rebalancing rules. The system includes an order submission module configured to transmit, via a network, the food order to a food machine of the set of food machines.

In other features, the order selection and display module is configured to, in response to receiving a selected culinary component from the user device, determine a permissible amount range for the selected culinary component based on a corresponding component rule of the set of component rules. In other features, the order selection and display module is configured to update the graphical user interface of the user device based on the permissible amount range. In other features, the rebalancing module is configured to maintain initial proportions of the subset of selected culinary components. In other features, the rules framework database further includes, for each constituent of a set of constituents, a maximum constituent amount. The rebalancing module is configured to, in response to a total amount of the constituent in the food order exceeding the maximum constituent amount, reduce an amount a subset of constituent-containing culinary components.

In other features, the rules framework database further includes a set of first portion rules corresponding to a first portion of the food order, and a set of second portion rules corresponding to a second portion of the food order. The rebalancing module is configured to identify a violation of at least one of (i) the set of first portion rules and (ii) the set of second portion rules and, in response to identifying the violation, adjust at least one of (i) an amount and (ii) a location of a subset of selected culinary components based on at least one of (i) a corresponding first portion rule of the set of first portion rules and (ii) a corresponding second portion rule of the set of second portion rules.

In other features, the rules framework database further includes a maximum order cost. The rebalancing module is configured to, in response to a cost of the culinary components in the food order exceeding the maximum order cost, reduce an amount of a subset of culinary components. In other features, the rules framework database further includes a set of food machine rules. The rebalancing module is configured to, in response to a violation of a subset of the set of food machine rules, modify an amount of a subset of culinary components. In other features, the system includes a menu update module configured to, in response to initiation of a food order, update the menu database.

In other features, the menu update module is configured to in response to receiving a selected culinary component from the user device, identify a food machine having a corresponding subset of food machine culinary components that includes the selected culinary component. The menu update module is configured to update the display on the graphical user interface based on the corresponding subset of food machine culinary components. In other features, the menu update module is configured to update the display by visually deemphasizing culinary components that are not included in the corresponding subset of food machine culinary components.

In other features, the rules framework database includes, for each culinary component of a subset of culinary components, a corresponding set of incompatible culinary components. The order selection and display module is configured to, in response to receiving a selected culinary component from the user device, identify that the culinary component is in the subset of culinary components. The order selection and display module is configured to, in response to identifying that the culinary component is in the subset of culinary components, update the display on the graphical user interface to visually deemphasize the corresponding set of incompatible culinary components.

The present disclosure encompasses methods including steps to implement any of the above operations performed by one or more systems. The present disclosure encompasses a non-transitory computer-readable medium storing instructions to execute any of the above methods.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a functional block diagram of an example establishment at which a culinary instrument is installed.

FIG. 1B is an example schematic representation of the culinary instrument of FIG. 1A.

FIG. 2 is a functional block diagram of an example mobile application for ordering food.

FIG. 3 is a functional block diagram of an example ordering system for interfacing with a mobile device used to order food.

FIG. 4 is a front view of a graphical user interface for a display screen depicting slider user interface elements.

FIG. 5 is a front view of a graphical user interface for a display screen depicting a graphical representation of an amount of a condiment selected.

FIG. 6A is an example element sauce instructions list.

FIG. 6B is an example element sauce instructions list.

FIG. 7 is a front view of a graphical user interface for a display screen depicting a graphical representation of an amount of a condiment selected.

FIG. 8 is an example flowchart depicting generation of customized food order instructions for transmission to a culinary instrument.

FIGS. 9A and 9B are example flowcharts depicting condiment customization in an order instruction for transmission to a culinary instrument.

FIG. 10 is an example flowchart depicting a rebalancing of condiments for an order instruction.

FIGS. 11A and 11B are tables including example condiment rules for a list of sauces and a list of seasonings.

In the drawings, reference numbers may be reused to identify similar and/or identical elements.

### DETAILED DESCRIPTION

The following description of the embodiment of the invention is not intended to limit the invention to these embodiments, but rather to enable any person skilled in the art to make and use this invention.

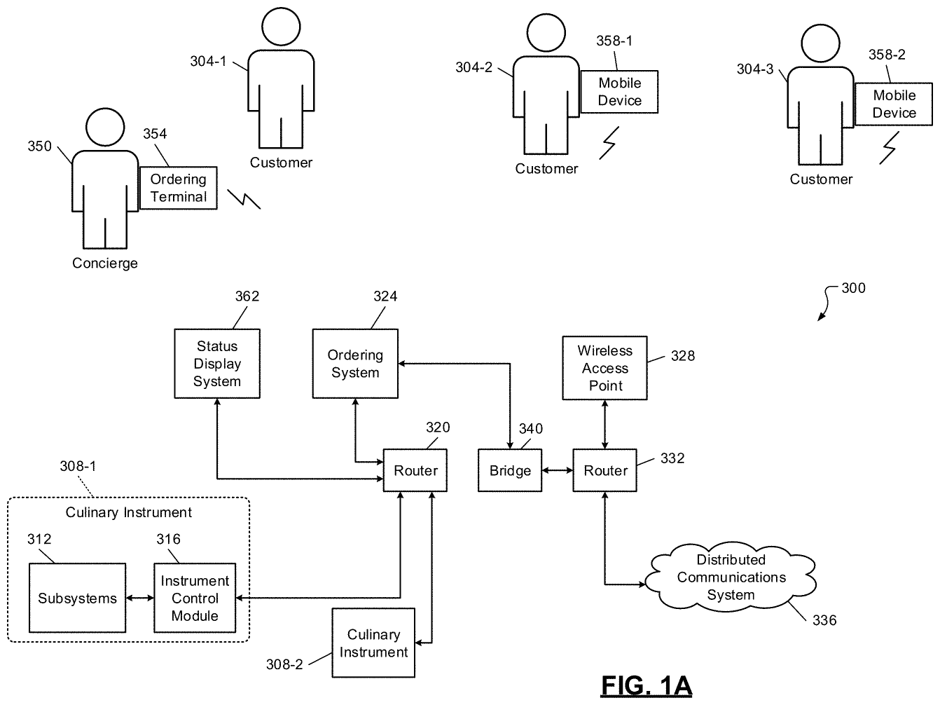

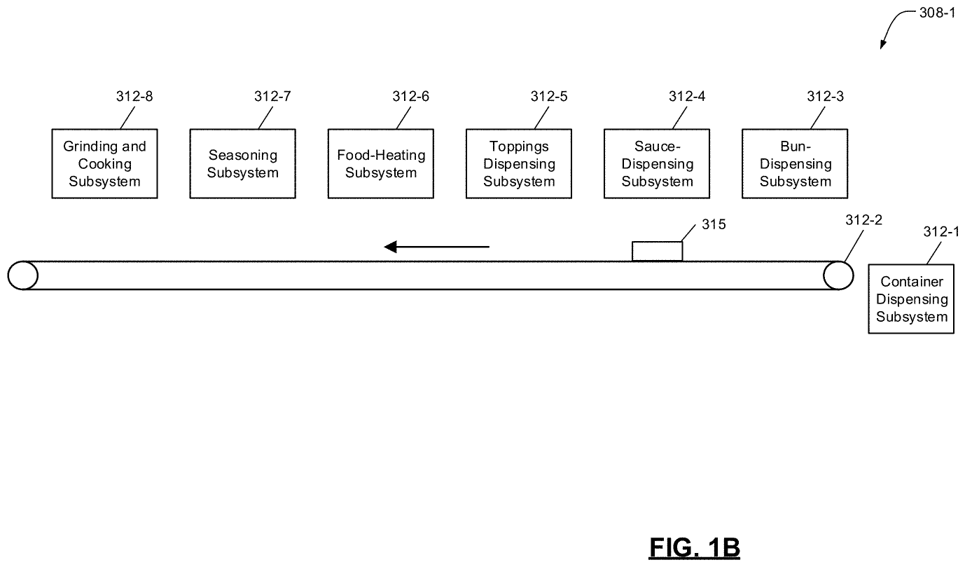

In FIG. 1A, customers 304-1, 304-2, and 304-3 are placing orders with an establishment 300 that includes a culinary instrument 308-1. For example, the culinary instrument 308-1 may be configured to create a food item, such as sandwiches (for example, hamburgers), bowls, and/or burritos. While the following discussion is in the context of hamburgers, some or all of the subsystems may be applicable to other types of food item.

Subsystems 312 of the culinary instrument 308-1 may include, for example, a subsystem that dispenses a container, a subsystem that slices, butters, and toasts hamburger buns, a subsystem that dispenses toppings, such as vegetables and/or cheese, a subsystem that dispenses liquid sauces, a subsystem that dispenses powdered seasonings, a subsystem that grinds and cooks meat, a subsystem that heats the food, such as to melt cheese, etc. The culinary instrument may also include a conveyor subsystem to transport food items between other subsystems.

In one example implementation, as shown in FIG. 1B, the culinary instrument 308-1 includes a container-dispensing subsystem 312-1 that places a container, such as a box 315, on a conveyance subsystem 312-2. A bun-dispensing subsystem 312-3 slices, toasts, and butters halves of a bun, then dispenses the bun halves in the box 315. A sauce-dispensing subsystem 312-4 dispenses sauce on one or both of the bun halves. A toppings-dispensing subsystem 312-5 prepares toppings, such as by slicing or grating, and dispenses the toppings on one or both of the bun halves. In various implementations, the toppings-dispensing subsystem 312-5 grates cheese and dispenses it onto one or both of the bun halves. A food-heating subsystem 312-6 heats the cheese to at least partially melt the cheese. A seasonings subsystem 312-7 dispenses seasonings onto one or both of the bun halves. A grinding and cooking subsystem 312-8 grinds a protein, such as meat, forms a patty, cooks the patty, and deposits the cooked patty onto one of the bun halves. The culinary instrument 308-1 may include different or additional subsystems.

Although a single box 315 is shown on the conveyance subsystem 312-2, multiple boxes 315 may be present at all or a portion of the subsystems 312-3-312-8 and the subsystems 312 may operate concurrently. The conveyance subsystem 312-2 may be configured to transport boxes continuously or intermittently. In various aspects, the conveyance subsystem includes multiple stations, such as one station per subsystem 312, that may operate independently of other stations, such as to advance a box 15 at a single station.

Subsystems 312 are coordinated by an instrument control module 316. A networking router 320 permits the instrument control module 316 to communicate with an ordering system 324. In various establishments, multiple culinary instruments may be present. As an example only, a second culinary instrument 308-2 is shown in FIG. 1A. A wireless access point 328 may provide wireless Internet access to customers of the establishment 300. A router 332 connects the wireless access point 328 to a distributed communications system 336, which may include the Internet.

The ordering system 324 may receive orders from the distributed communications system 336 via a bridge 340, which may bridge between the ordering system 324 on an internal network and the router 332 on an external network. Orders may also arrive in the order system 324 via the wireless access point 328. In various implementations, a second internal wireless network may be used to allow employee devices to communicate with the ordering system 324 without traversing the bridge 340. For example, a concierge 350 may assist customers, such as the customer 304-1, with placing orders using an ordering terminal 354.

The ordering terminal 354 may wirelessly communicate with the wireless access point 328 or, because the ordering terminal 354 is owned by the establishment 300, with a wireless access point (not shown) that communicates with the ordering system 324 without traversing the bridge 340. As an example only, the ordering terminal 354 may be a kiosk implemented with a Windows operating system computer, a MacOS operating system computer, or an iOS operating system tablet. The customer 304-2 may place an order using a mobile device 358-1, such as an iOS operating system smartphone. Similarly, the customer 304-3 may place an order using a mobile device 358-2. One or both of the mobile devices 358 may be present in the establishment 300 and use the wireless access point 328 to obtain Internet access. In other implementations, one or both of the mobile devices 358 may connect to the distributed communications system 336 via another path, such as a different wireless local area network or a cellular network.

The orders are received and managed by the ordering system 324. In various implementations, the ordering system 324 may assign an order to either the culinary instrument 308-1 or the culinary instrument 308-2 depending on availability of ingredients and timing. In various implementations, a remote server may assign orders originating outside of the establishment 300 to a selected establishment that can provide a customer's precise order. Once the order has been assigned to the establishment 300, the ordering system 324 may then decide which of the culinary instruments 308 will receive the order. A status display system 362 includes a visual display, such as a liquid crystal display (LCD) screen, and a control module to drive the display as described in more detail below.

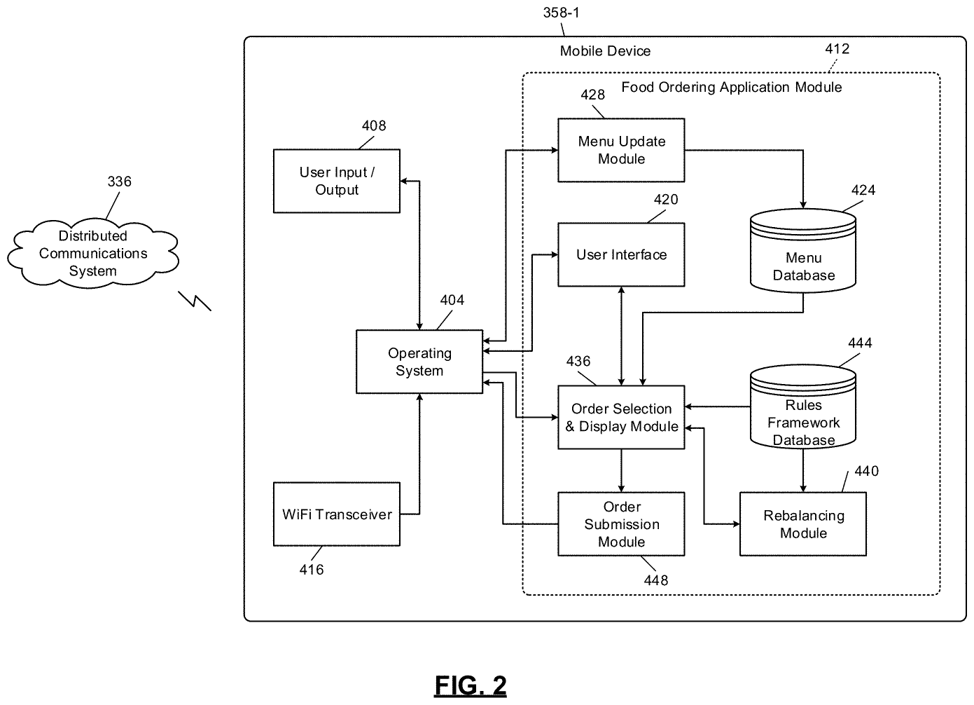

FIG. 2 is a functional block diagram of an example mobile application for precisely ordering food from a precision-capable culinary instrument. As described in FIG. 1A, a mobile device 358-1 operated by a user can submit an order using a food ordering application. The order is submitted over the distributed communications system 336. The mobile device 358-1 includes an operating system 404 that communicates user input and output 408 to a food ordering application module 412. As described previously, the food ordering application module 412 can be downloaded from the Apple App Store digital distribution platform or the Google Play Store digital distribution platform.

The mobile device 358-1 includes a WiFi transceiver 416 to communicate with the culinary instrument 308-1 of FIG. 1A over the distributed communications system 336. The food ordering application module 412 includes a user interface 420 that displays ingredient options to the user operating the mobile device 358-1. The user interface 420 receives user input 408 from the user via the operating system 404.

A menu database 424 stores a list of ingredients (also referred to as “culinary components”) available on nearby culinary instruments or culinary instruments at favorited establishments. In various implementations, the menu database 424 stores the list of ingredients available on multiple culinary instruments. When the user loads a menu, the menu includes the list of ingredients available on each culinary instrument. Therefore, if the user selects a particular ingredient unique to one of the culinary instruments or a subset of the culinary instruments, then the list of ingredients is updated according to the ingredients available on that particular culinary instrument or subset of culinary instruments.

For example, if smoked cheddar is selected and only one culinary instrument has smoked cheddar, then the order is directed to that culinary instrument. Further, the visible menu is adjusted according to the list of ingredients available on that culinary instrument or greying out the items unavailable on that culinary instrument. A menu update module 428 updates the menu database 424 intermittently and/or each time a new order is initiated using the food ordering application. The menu update module 428 is configured to obtain a current list of ingredients for a set of culinary instruments and store the list of ingredients with the corresponding culinary instrument in the menu database 424. As mentioned above, the menu update module 428 may adjust the current list of ingredients according to a selected ingredient, which may dictate or limit the culinary instrument capable of completing the order.

In various implementations, the menu update module 428 selects the set of culinary instruments from which to obtain the list of ingredients based on a current location of the mobile device 358-1, a previously favorited restaurant location, or a history of restaurant locations from which the user has previously ordered. The list of ingredients is updated in response to a user initiating a new order to ensure the displayed ingredients are presently available for the user to order. In various implementations, the ingredients list stored in the menu database 424 is replaced during each update. The list of ingredients is also updated in response to a determination that certain ingredients have been refilled. A plurality of sensors may be placed on the culinary instruments to sense a volume of each ingredient to make the determination.

An order selection and display module 436 obtains the list of ingredients from the menu database 424 and displays the list of ingredients on the user interface 420. The order selection and display module 436 receives selections of ingredients from the user when the user selects a particular ingredient from the displayed list of ingredients on their mobile device 358-1. The order selection and display module 436 generates and updates order instructions that are forwarded to the culinary instrument upon the user choosing to complete their order by selecting a complete order user interface element. The order selection and display module 436 receives user input 408 indicating which ingredients of the displayed list of ingredients to include in the order instructions of the order.

For certain ingredients, the user may select an amount of the ingredient as well as a location of the ingredient. For example, when selecting a condiment, such as a sauce or a seasoning, the user may select an amount of sauce to include in the order as well as a location. In various implementation, the order may be a food order for a hamburger, a bowl, or another food item. A hamburger may also be referred to as a burger, and is not restricted to only sandwiches with beef patties—in fact, the term “hamburger” used here encompasses sandwiches with vegetable-based proteins and other forms of animal-based proteins.

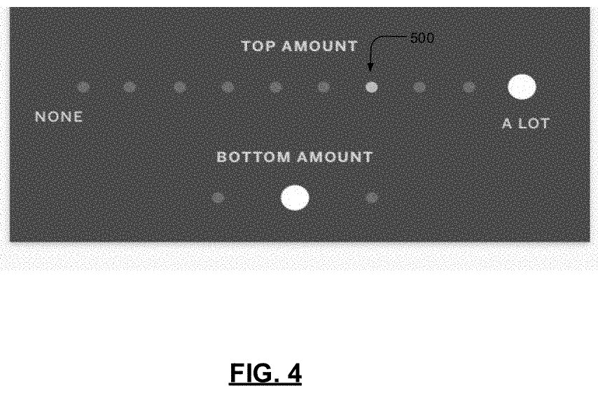

In the case of a burger, the user may select anywhere from no condiment to a lot of the condiment located on each bun (the top bun and the bottom bun), as indicated by the slider shown in FIG. 4. As described in more detail below, the user may also select which side of the bun to place the condiments. While the term bun is used throughout the present application, the condiment may be shown on a side of a bowl, a layer of a recipe on a bowl or plate, a side of a bun, etc.

While each order is customizable by the user sliding the amounts of each condiment, a number of constraints are implemented by the order selection and display module 436 and a rebalancing module 440. The order selection and display module 436 and the rebalancing module 440 adjust the order according to a rules framework. The rules framework considers constraints including timing constraints of order preparation, taste or health constraints (for example, sodium), culinary instrument constraints, and pricing constraints. To follow these constraints, the rebalancing module 440 obtains rules for certain ingredients and the type of order from, for example, a rules framework database 444 that stores seasoning rules, sauce rules, burger rules, and bowl rules. The order selection and display module 436 also obtains rules from the rules framework database 444 and restricts ordering based on the obtained rules.

During order creation, the order selection and display module 436 updates the order instructions based upon user selection. The order selection and display module 436 also updates the user interface 420 according to which ingredients have been added to the order. For example, if the user selects to add two tomato slices, the order selection and display module 436 will update an order image to include two tomatoes. Similarly, the order selection and display module 436 will update the order display on the user interface 420 during sauce and seasoning selection.

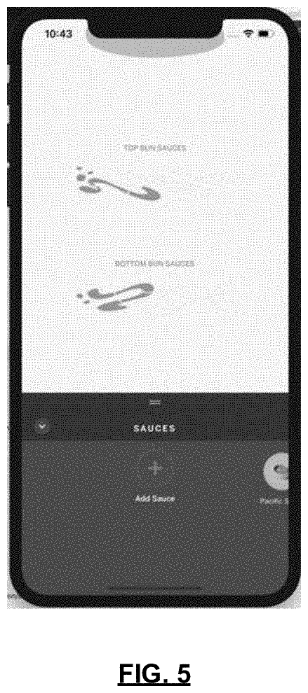

As shown in FIG. 5, the sauces available include, but are not limited to, Oyster Aioli, Mustard, Mayonnaise, Pacific Sauce, Mushroom Sauce, BBQ Sauce, Charred Onion Jam, Ketchup, Charred Scallion Garum, Scallion Mayo, Baconnaise Sauce, Presidio Sauce, Tomato Pickle, Chili Achaar, and Mango Chutney Aioli. As is true with the seasonings, each sauce has a maximum amount allowed. Additionally, a maximum of three different sauces may be included in the rules framework to ensure that excellent taste is preserved. As is also true with the seasonings, if the user selected too much sauce, per side or overall, the food ordering application maintains the intended or requested ratio (or proportions, in the case of more than two ingredients) the sauce request and reduces each sauce proportionally to preserve the user's taste intent. While the present application describes sauce measurements in mL increments, other measurement amounts may be used, such as shots, a serving size, a dose, a helping, etc.

In various implementations, the food ordering application may include in the rules framework a constituent maximum. In an example, an constituent maximum includes a sodium maximum. In the implementation of having a constituent maximum, instead of the ratio being preserved, the food ordering application may instead specifically reduce the amount of high-constituent ingredients available to add by dynamically adjusting the maximum of those ingredients.

In various implementations, the food ordering application may include in the rules framework rules preventing two incompatible ingredients, such as two sauces. The ingredients may be defined as incompatible based on culinary considerations, machine limitations, and/or cost. Preventing incompatible ingredients from being included from being included on the same order may therefore preserve taste, prevent machine backup, and/or maintain cost within a desired range.

In various implementations, the food ordering application may include in the rules framework a cost maximum. In the implementation having the cost maximum, the ratio of ingredients may be preserved while lowering amounts of each ingredient, proportionally, until the order cost is within the predetermined or desired range. In another example, the food ordering application may instead specifically reduce an amount of one or more high-cost ingredients.

In various implementations, when rebalancing the condiment amount, the rebalancing may occur over the entire order (that is, both sides of a burger) or for a particular side. For example, if the user has exceeded the first side maximum but has no condiments on the second side, the food ordering application may automatically rebalance the amount, according to the ratio, across both sides. Further, particular condiments, according to their taste profile, may have a default, preferred side placement, which may influence which condiments are rebalanced to another side. In various implementations, the rebalancing may also occur as a result of adding more condiments. For example, condiments may be adjusted in amount or location based on a flavor profile, selected recipe profile, according to user preference, etc.

The seasonings include, but are not limited to, salt combos, spicy combos, Sea Salt, Garlic Salt, Alderwood Smoked Sea Salt, Chipotle Sea Salt, Habanero Sea Salt, Pacific Seasoning, Persian Lime Pepper, Black Pepper, Masala, and Smoky Habanero. As described later, the seasonings are added to the food order in “dash” increments, allowing the user to select a limited number of dashes based on the seasoning type as well as an overall number of dashes. These maximums consider culinary constraints as well as machine constraints, ensuring the taste is excellent and the order does not hold up the queue. The maximums may also consider cost constraints. In various implementations, the number of overall dashes on a burger is limited to seven, with only four dashes per side, and only three different types of seasoning. However, if the user has already selected three sauces, the number of seasonings is limited to two. In various implementations, only two seasonings may be added to one side.

For example, as shown in FIG. 5, a sauce selection screen is depicted. The user may navigate to this screen from the home page and add a sauce to their order. Once a sauce is selected, the user can adjust the slider shown in FIG. 4 to adjust the amount of the particular sauce on each bun or side. A display may depict sauce on the top and bottom bun, as well a slider input for the user to adjust the amount of sauce.

During order creation, the order selection and display module 436 adjusts the display of condiment amount to depict a proportional amount of condiment that is being selected. For example, the user may select that the top bun sauce includes five out of the nine increments of the seaweed sauce. As the user slides the amount slider to include more seaweed sauce, the order selection and display module 436 adjusts the display on the user interface to indicate the amount of seaweed sauce is increasing by filling in two additional portions of the nine portions.

The order selection and display module 436 also updates the slider input scale, shown in FIG. 4, based on which sauce is being adjusted. According to the rules framework, each condiment or ingredient has a maximum and minimum amount, which is based on culinary preferences, culinary instrument constraints, and surface area constraints of the type of order being created (that is, an amount of space for condiments on a bun or amount of space in a bowl for sauce). In various implementations, each available bun for selection includes different maximums and minimums of condiments in the rules framework according to the bun surface area. The culinary preferences may consider a spiciness level, a sodium level, or other culinary features, such as including a rule that a particular set of condiments may not be combined. These culinary preferences may set a maximum amount of condiment due to spiciness or sodium level, but also may guide a minimum amount of condiment so that the condiment can be tasted.

The culinary instrument constraints include considerations such as speed of fulfilling a number of condiments, for example, by setting a total number of a type of condiment to three to prevent the culinary instrument from interfering with the takt time of order fulfillment. The takt time of a fulfillment queue maintains the pace of order fulfillment so that each order remains at each ingredient location along the conveyor for an expected or average amount of time. Further, limiting the total number of condiments at each ingredient station may also provide culinary benefit as too many competing flavors may create a poor culinary experience. Additionally, culinary instrument constraints include physical features. For example, in the example of placing two slices of tomatoes, depending on the height of the order and location of the ingredients being supplied to the order, a third tomato slice may not be feasible if not enough vertical physical space exists.

The pricing constraints include considerations such as ingredient costs. The rules framework database 444 may include ingredient maximums for a set of high-cost ingredients, such as ingredients having greater than or equal to a predetermined cost. Additionally or alternatively, the rules framework database 444 may include an order cost maximum. The order cost maximum may be based on economic considerations of a restaurant, such as when the order cost to the customer is fixed. In various implementations, the order price may vary, allowing the customer to determine whether additional quantities of more expensive ingredients are worthwhile.

Based on the above considerations, the rules framework provides the minimum amount of condiments for each condiment, which is stored in the rules framework database 444. Therefore, when the order selection and display module 436 receives a user selection of a condiment, the order selection and display module 436 obtains a set of rules for the particular condiment from the rules framework database 444. Then, the order selection and display module 436 determines the scale of the slider input that the user adjusts based on the minimum and maximum amount allowed for the particular condiment.

For example, mayonnaise has a minimum amount of 8 ml and a maximum amount of 24 ml per bun or side. Therefore, the increments of the 10 dots along the slider input (shown in FIG. 4) are adjusted accordingly. For example, the first dot above the word “none” is always zero ml. Since the minimum amount of mayonnaise is 8 ml, the second dot is 8 ml. Additionally, since the maximum amount of mayonnaise is 24 ml, the tenth dot above the word “a lot” is equal to 24 ml. Then, dots three through nine are spaced evenly, incrementing upward by an amount of 2 ml.

As the user moves the slider, the amount of the condiment displayed on the user interface 420 is adjusted accordingly. For example, as shown in FIG. 5, nine fillable segments on each bun side indicate the amount of sauce selected for a burger. The rules framework database 444 includes, for each order type (burger, bowl, etc.), a maximum total amount of condiment that can be added, based on the previously discussed constraints. Additional maximums may also be included in the rules framework database 444. For example, when creating a burger, each bun has a maximum amount of condiments that can be selected. In various implementations, based on the above considerations, each bun side may be limited to 32 ml, for a total amount of 64 ml.

Therefore, to indicate the amount of sauce distributed on each bun, the nine fillable segments are filled with a corresponding sauce color or gradient based on the amount of sauce included out of the total amount of sauce allowed on the bun. To determine a number of segments to fill, the order selection and display module 436 multiplies the requested sauce amount (indicated by the slider) by nine and then divides the resulting amount by the maximum amount allowed. The result may be rounded up and, if multiple sauces are included on the bun and the rounded up number of segments for each sauce exceeds nine, then one segment is subtracted from the largest segment until the sum of segments equals nine.

In this case, if the user selected a maximum amount of mayonnaise (24 ml) and the total amount per bun is 32 ml, then 24*9/32 is 6.75. Rounding up results in seven segments being filled with a color or shading corresponding to mayonnaise, such as an off-white color. Similar logic may be implemented for an amount of seasonings, where a particular seasoning may be added in dash increments and, for each dash added, additional speckles corresponding to the selected seasoning are displayed on the user interface on the appropriate side. Similar to the description of the sauce segments above, the seasoning segments may include four segments overlapping one another to show a small to large amount of seasoning that is selected.

The order selection and display module 436 also obtains a maximum number of sauces from the rules framework database 444, for example, only allowing three different sauces to be included on one order. To enforce a maximum number of condiments rule, the order selection & display module 436 prevents selection of an additional sauce or seasoning after the maximum number has been added to the order. For example, the order selection and display module 436 may grey out the add sauce selection on the user interface 420, preventing the user from selecting an additional sauce once three sauces are added. However, the user may still be able to adjust the amount of condiments already included in the order.

Once the condiment selection is complete, indicated by the user completing and submitting the order or returning from the condiments page to a home screen, the order selection and display module 436 forwards the order instructions for at least the condiments to the rebalancing module 440. The rebalancing module 440 determines whether the order instructions violate any rules included in the rules framework database 444 and adjusts the order instructions as needed.

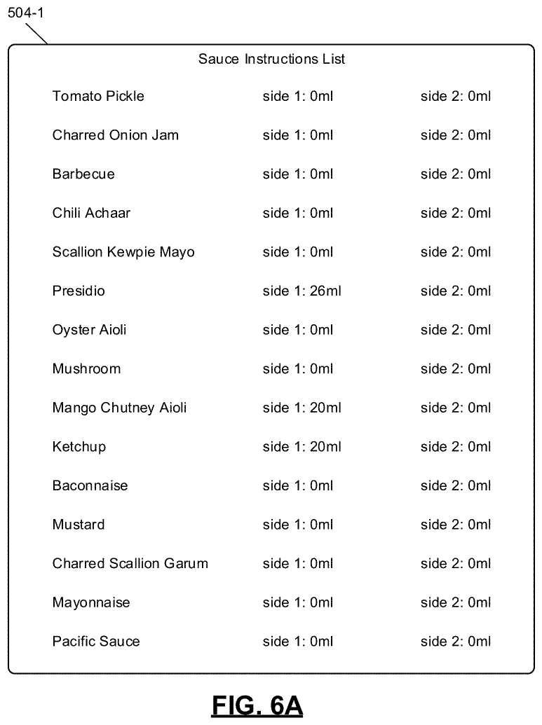

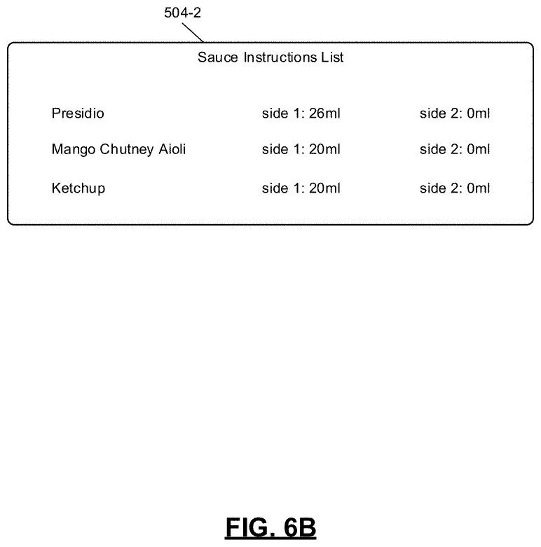

For example, if the order instructions include three different sauces, and the maximum number of each sauce was input by the user using the slider, the sauce portion of the order instructions may appear as shown in the sauce instructions list 504-1 of FIG. 6A.

In various implementations, such as is illustrated in FIG. 6B, the sauce instructions list 504-2 may only include the sauces that have been added to the order. As shown, on side 1, the instructions include 26 ml of presidio sauce, 20 ml of mango chutney aioli, and 20 ml of ketchup. Therefore, the 32 ml per side maximum is exceeded. The rebalancing module 440 determines the ratio of the selected sauces, in this case 13:10:10, and adjusts the amount of each sauce to maintain the ratio requested by the user.

For example, the rebalancing module 440 can determine an overage, in this example the sauce amount exceeds the maximum by 34 ml; therefore, the rebalancing module calculates an average amount by which to reduce each sauce. Since 34 divided by three sauces is 11.33, the rebalancing module 440 reduces each sauce by 11 ml, resulting in 15 ml of presidio sauce, 9 ml of mango chutney aioli, and 9 ml of ketchup. Since the total amount of sauce on side one is still over by 1 ml, the rebalancing module 440 reduces the largest quantity of sauce by 1 ml, in this case, the presidio sauce is reduced to 14 ml. In various implementations, the overage may be provided on the side, in a separate container to allow the user to add as desired. In such an implementations, condiments in excess of the maximum number of condiments may also be added on the side, such as including a fourth sauce in a separate container.

The rebalancing module 440 adjusts the order instructions and forwards the adjusted order instructions back to the order selection & display module 436. Once the order is complete, rebalanced as needed, and the user selects a complete order button, the order instructions are forwarded to an order submission module 448 that is configured to forward the order instructions to the corresponding culinary instrument. In various implementations, the rebalancing module 440 may perform the rebalancing after the order is completed but prior to order submission and forwards the order instructions to the corresponding culinary instrument.

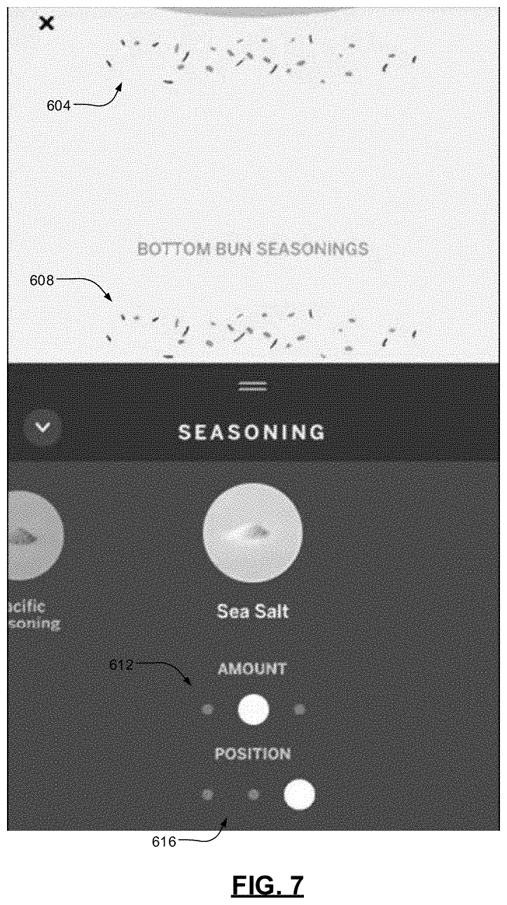

As shown in FIG. 7, a user interface displaying seasonings selected for a new order is shown. On a first side 604 at the top of the user interface, speckles are shown indicating seasoning on a top bun and below the words “bottom bun seasonings,” speckles are shown on a second side 608 indicating seasoning on a bottom bun. An amount slider 612 expands upon user selection, shown in FIG. 4, to allow the user to select none or a lot of the seasoning. A position slider 616 allows the user to adjust the amount of seasoning on the first side 604, the second side 608, or split between the two sides. In various implementations, the sauce user interface may also include the position slider, in which case, the sauce is split evenly on the first and second side, still obeying the minimum and maximum condiment rules. In various implementations, a dot 500 may be shaded a different color from the rest to indicate a recommended amount.

In various implementations, in addition to recommending an account, the food ordering application may also recommendation which condiments pair or combine well with selected condiments. For example, once a user selects the addition of a first condition, the food ordering application may generate and display a user interface element next to a set of condiments indicating that the condiment would pair or combine well with the condiment(s) presently selected.

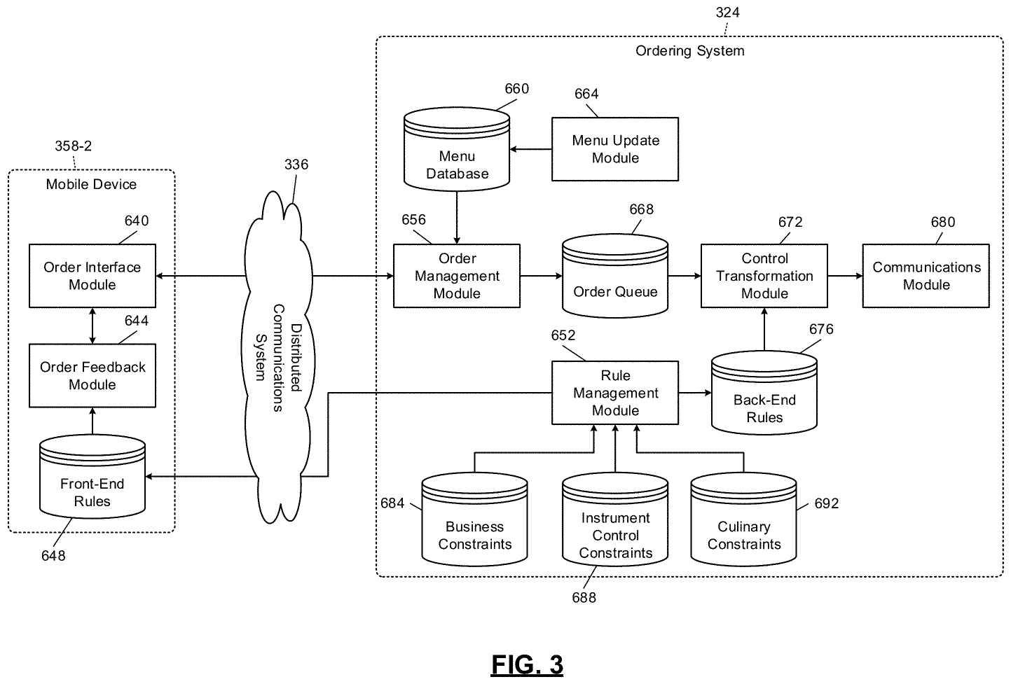

The food ordering application adds seasonings to the order similar to adding sauces; however, in various implementations, the seasonings are added to the order in set amounts or “dashes.” A dash may be a set value equal to a teaspoon or another measured amount, such as grams or predefined gram increments. For example, the number of dashes of each seasoning may have a maximum value, indicated in the rules framework database 444 of FIG. 2 or 3, with one dash being the minimum value for each seasoning. Rebalancing dashes for the order may include rebalancing which side the seasoning is on while maintaining the overall ratio of the requested seasonings.

Additionally, each bun or side may have a maximum number of dashes and the order may have an overall number of dashes, for example, 4 dashes per side with 7 dashes total per order. The amount slider 612 is scaled according to the maximum number of dashes of the particular seasoning. The rebalancing module 440 of FIG. 2 or 3 will adjust the number of dashes requested by preserving the ratio of the seasonings and ensuring the maximum number of dashes is not violated. In various implementations, the condiment maximums and minimums are dictated by the culinary instrument constraints. For example, the culinary instrument may only be capable of dispensing a minimum amount of sauce in mL as well as a minimum of seasoning in the form of one dash.

Referring back to FIG. 3, another implementation of the ordering system 324 and a mobile device ordering system are shown. The mobile device 358-2 is shown as an example, and schematically includes an order interface module 640, an order feedback module 644, and a front-end rules data store 648. These components may be integrated into an app running on the mobile device 358-2 and may be downloaded from a digital distribution platform, such as the PLAY STORE from Google or the APP STORE from Apple. As examples only, the app may be a native app or may be HTML5 wrapped into an app.

The front-end rules data store 648 is populated by a rule management module 652. In various implementations, the front-end rules data store 648 may be populated prior to distribution by the digital distribution platform. In various implementations, the front-end rules data store 648 may be updated from the rule management module 652 when first run, on every run, or on a periodic basis. As a user of the mobile device 358-2 uses the order interface module 640 to select food items to order, the user may wish to adjust certain components of the food items. These adjustments may include increasing or decreasing culinary components included by default in the recipe of a food item or may include adding culinary components not included by default in the recipe. For example, the user may wish to add additional liquid sauces or dry seasonings.

Based on rules defined by the front-end rules data store 648, the order feedback module 644 enforces constraints on adjustments made by the user and may provide recommendations to the user based on cost, taste, and timing. For example, the order feedback module 644 may indicate to the user that a certain combination of culinary components will lead to a greater cost for the food item. In various implementations, the order feedback module 644 may provide real-time feedback on item cost as components are adjusted. In various implementations, only some culinary components or combinations of culinary components are associated with increased cost.

As another example, the order feedback module 644 may indicate to the user that a certain combination of culinary components will stack up too high and will not be able to be produced. For example, if tomato slices are one of the culinary components, slicing too many tomato slices onto a food item may cause the food item to be too tall to create sufficient clearance under other dispensing stations. Further, slicing more than one—or more than two—tomato slices may not be possible within the culinary instrument's takt time. As a result, either the entire pipeline must halt so the food item can occupy the tomato station for another takt time or the number of tomato slices must be reduced.

The order feedback module 644 may allow the user to pay more to add culinary components that will force the food item to occupy multiple takt times at one station. However, at busy times, the order feedback module 644 may not permit this. Whether the culinary instrument is busy may be a flag communicated to the order feedback module 644 while the user is placing an order.

The order interface module 640 communicates with an order management module 656 of the ordering system 324. Note that functional blocks shown in FIG. 3 may be relocated, split, joined, or otherwise rearranged according to the objectives of the implementation. Some of the components may be executed on premises (at the location of the culinary instrument) while others may be executed in an off-site hosting facility, such as a leased physical space in a data warehouse or within a virtual cloud facility such as AMAZON WEB SERVICES from Amazon.

The order management module 656 communicates menu information to the order interface module 640 from a menu database 660. The menu database 660 may include a list of food items offered by a restaurant, some or all of which can be crafted in whole or in part by the culinary instrument. For each food item, the menu database 660 specifies a set of culinary components and amounts. For example, the amounts may be specified in different units. A protein patty may be specified in ounces and a set number of different sizes (for example, 4) may be possible. Tomato culinary components may be specified as a number of slices of predefined width. In various implementations, the width of the tomato culinary component may be specified. Further, amounts in milliliters of certain sauces may be specified for each food item.

A menu update module 664 updates the menu database 660 based on the availability of certain components. For example, if a particular sauce is out of stock, the menu update module 664 may set a flag making food items with that particular sauce unavailable for order. The menu database 660 may also specify culinary attributes of each culinary component, such as calories, sodium, and fiber per unit (for example, per protein patty or per milliliter).

Once the user completes adjustments to a food item, the order interface module 640 provides information about the food item and the adjustments to the order management module 656, which may queue the food item in an order queue 668. The order queue 668 is read by a control transformation module 672, which applies rules from a back-end rules data store 676 to the food item in order to determine a set of instructions to control the culinary instrument. The set of instructions are provided to the culinary instrument via a communications module 680, which may access the culinary instrument through an application programming interface (API), such as a REST API.

The back-end rules may encode specific constraints of the culinary instrument, such as the minimum amount of a particular culinary component that can be dispensed. For example, a certain number of milliliters of sauce must be dispensed in order to achieve an acceptable degree of accuracy. Further, the total amount of sauce may be limited by a number of revolutions of a pump. As a result, a desired volume of 9 milliliters (just as an example) may actually have to be controlled as either 8.8 or 9.2 milliliters. This selection of a discrete step may be referred to as quantization.

The rule management module 652 adjusts the back-end and front-end rules. For example, as costs of culinary components change, the rule management module 652 may adjust cost-based rules. The rule management module 652 may rely on business constraints 684, such as culinary component costs; instrument control constraints 688, such as takt time; and culinary constraints 692, such as total recommended sodium level. In various implementations, the constraints may be predefined and/or may be learned over time. For example, based on feedback obtained from customers, maximum acceptable sodium levels may be learned over time.

Referring to FIG. 8, an example flowchart depicting customized food order instruction creation for transmission to a culinary instrument is shown. Control begins in response to receiving a food order initiation. The food order includes a food order type, for example, a bowl or a burger, including a surface area. The rules framework accounts for the type of order being initiated and has a threshold condiment, ingredient, or component maximum based on the food order type.

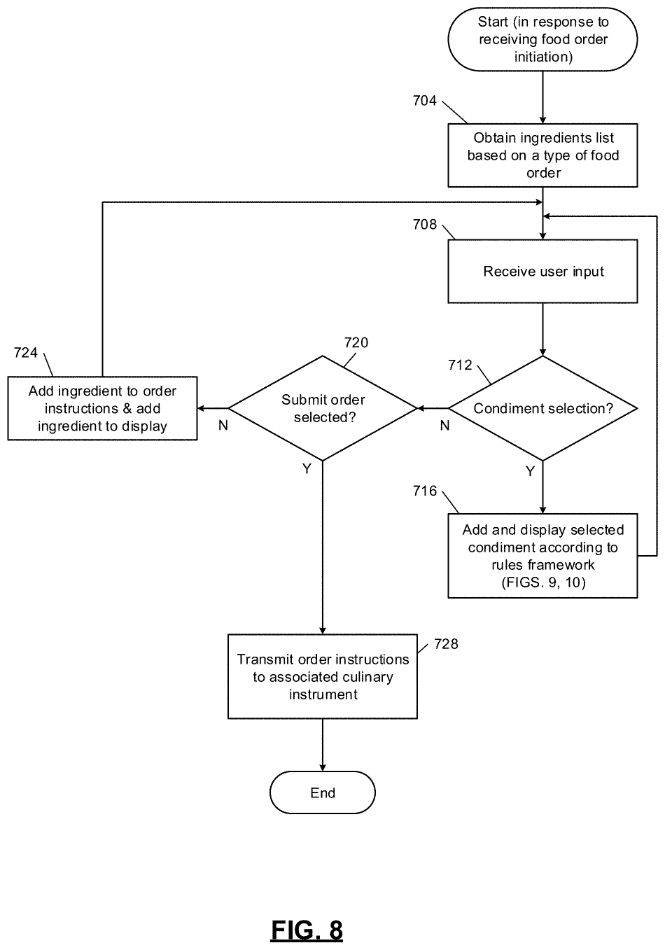

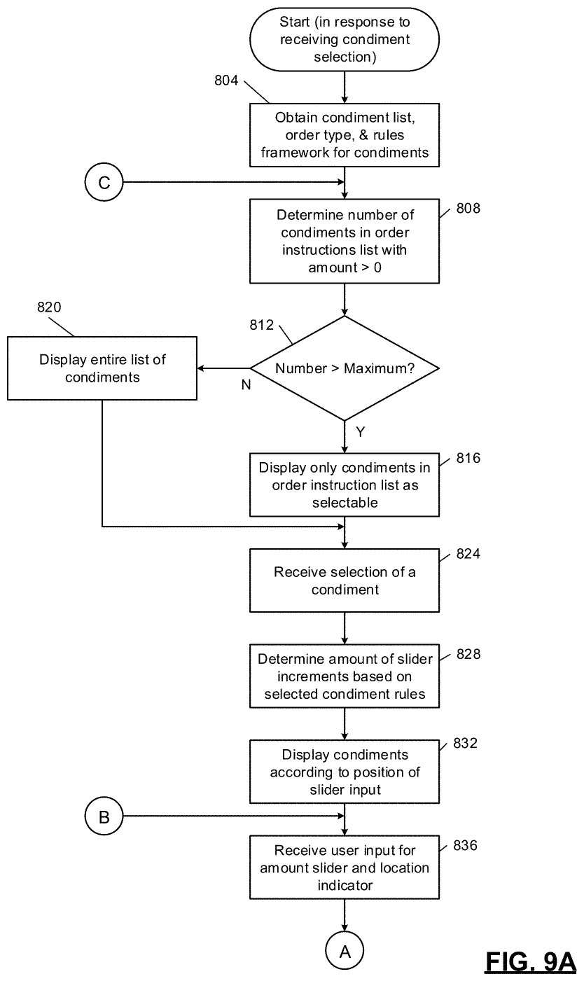

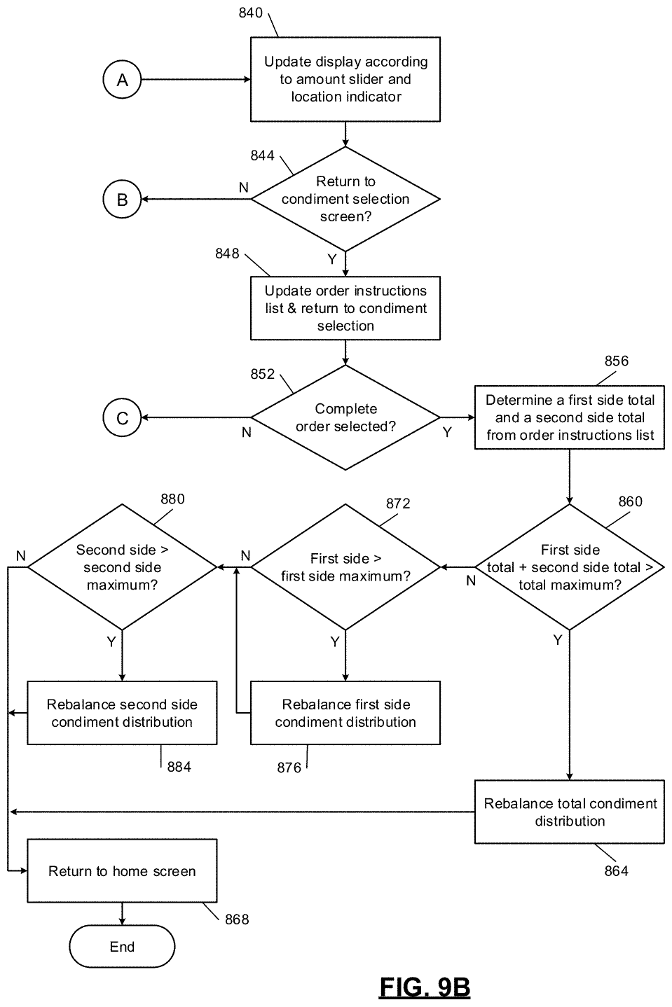

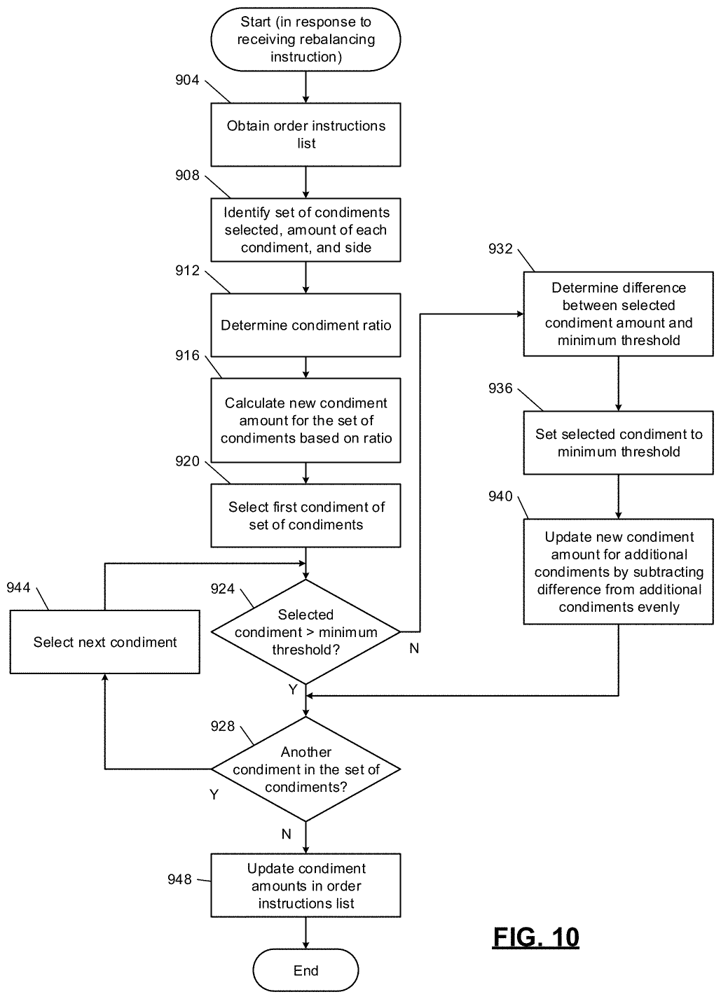

At 704, control obtains an ingredients list based on a type of the food order included in the food order initiation. Control continues to 708 to receive user input. Control proceeds to 712 to determine if a condiment was selected. If yes, control continues to 716 to add and display the selected condiment according to rules framework of the food order type and the condiment, described in flowcharts of FIGS. 9A-10. Then, control returns to 708. Otherwise, control continues to 720 to determine if the user selected to submit the order. If no, control proceeds to 724 and assumes the user selected an ingredient that is not a condiment and adds the ingredient to the order instructions and displays the ingredient on the user interface of the food ordering application. In various implementations, additional selections may be included to avoid an assumption that an ingredient was selected. Then, control returns to 708. Otherwise, if the user selected to submit the order, then control continues to 728 to transmit the order instructions to the associated culinary instrument.

Referring now to FIGS. 9A and 9B, example flowcharts depicting condiment customization in an order instruction for a culinary instrument are shown. Control begins in response to receiving a condiment selection. Control continues to 804 to obtain a condiments list, an order type, and a rules framework for the list of condiments. Control continues to 808 to determine a number of condiments in the order instructions list with an amount greater than zero. For example, if the user selected a preset food order and then navigated to adjust the amount of default condiments included in the preset food order, the order instructions would already include certain condiments.

Control proceeds to 812 to determine if the number of condiments is greater than a maximum allotted amount of condiments. For example, a condiment may be a sauce or a seasoning. To maintain queue speed in the culinary instrument and prevent unpleasant taste profiles, the number of sauces may be limited to three as well as the seasonings. However, the number of seasonings may be limited based on the number of sauces. For example, if the order instructions include three sauces, then the number of seasonings may be limited to two; otherwise, the number of seasonings may be limited to three. Therefore, a total number of condiments may be limited to five.

If, at 812, the number of condiments exceeds a maximum number included in the rules framework, then control continues to 816 to display condiments listed in the order instruction as selectable and display condiments not included in the order instructions as unselectable. For example, control may grey-out the unselected condiments to prevent the user from adding more condiments. However, the condiments already included in the order instructions maintain selectable so that the user can adjust the amounts as desired. Otherwise, if the number of condiments does not exceed the maximum, then control continues to 820 to display the entire list of condiments.

Control proceeds from 816 and 820 to 824 to receive selection of a condiment from a user on the user interface of the food ordering application. Control continues to 828 to determine an amount of slider increments or intervals based on selected condiment rules included in the rules framework. That is, as described previously, the slider input is adjusted according to maximums and minimums of the selected condiment. Control continues to 832 to display condiments on the display of the user interface according to the position of the slider input. Control continues to 836 to receiver user input for the amount slider and the location indicator (as shown in FIG. 7). Control continues to 840 in FIG. 9B to update the display according to the amount slider and location indicator.

Then control proceeds to 844 to determine whether the user selected to return to the condition selection screen, including a list of condiments. In various implementations, the available condiments are included on the bottom of the display, preventing the need for a separate condiment selection screen. If yes, control continues to 848 to update the order instructions list to include the selected condiment, along with the amount indicated by the amount slider and the position according to the location indicator, and return to the condiment selection screen.

Otherwise, control returns to 836 to wait for additional user input. Once the order instructions list is updated and control returns to the condiment selection screen at 848, control continues to 852 to determine if a complete order button was selected. If no, control returns to 808 to display the appropriate condiments for selection based on a total number of condiments included in the order instructions. Otherwise, control continues to 856 to determine a first side total and a second side total of condiments included in the order instructions list. In various implementations, control may only determine a total amount of requested condiments independent of side placement.

Then control continues to 860 to determine if the overall total is greater than a total maximum included in the rules framework for the order type. If yes, control proceeds to 864 to rebalance the total condiment distribution. Rebalancing the total condiment distribution may include altering the placement of the condiments to achieve the requested ratio and amount. For example, if the user selected an amount of sauce above the maximum amount of sauce to be included on the top or first side, the rules framework may instruct, if there is room on the bottom or second side, redistribution or rebalancing of sauces to include the same amount of sauce, but on different sides. In various implementations, such a rebalancing and redistribution may be based on a taste or culinary profile that indicates preferred placement of a particular condiment or sauce.

After the condiment distribution is rebalanced at 864, control continues to 868 to return to the home screen. In various implementations, control may proceed to a successful ordering screen. If, at 860, the total maximum is not exceeded, control determines at 872 if a first side condiment total exceeds a first side maximum according to the rules framework. If yes, control proceeds to 876 to rebalance the first side of the condiment distribution. Otherwise, control continues to 880 to determine if a second side total exceeds a second side maximum according to the rules framework. If yes, control continues to 884 to rebalance the second side condiment distribution. Otherwise, control proceeds to return to the home screen at 868. Then, control ends.

Referring to FIG. 10, an example flowchart depicting a rebalancing of condiments for an order instruction is shown. Control begins in response to receiving a rebalancing instruction, for example, as shown at 864, 876, or 884 in FIG. 9B. Control continues to 904 to obtain the order instructions list. Control proceeds to 908 to identify a set of condiments selected from the order instructions list, including an amount of each selected condiment and a side each condiment is located. Control continues to 912 to determine a condiment ratio total and a ratio for each side based on the rebalancing instruction. Control proceeds to 916 to calculate a new condiment amount for the set of condiments based on the ratio to ensure the maximum amount of each side and total are not violated. As described above, the overage may be subtracted from each sauce evenly to not exceed the maximum allotment.

Control continues to 920 to select a first condiment of the set of condiments. Then, control proceeds to 924 to determine if the selected condiment exceeds a minimum threshold according to the rules framework. If yes, control proceeds to 928 determine if another condiment is in the set of condiments. Otherwise, control continues to 932 to determine a difference between the selected condiment amount and the minimum threshold included in the rules framework. Control proceeds to 936 to set the selected condiment amount to the minimum threshold. Then, at 940, control updates the new condiment amount for additional condiments by subtracting the difference from the additional condiments evenly.

Control then returns to 928 to determine if additional condiments are in the set of condiments. If yes, control continues to 944 to select the next condiment and return to 924. Otherwise, control proceeds to 948 to update the order instructions list with the new condiment amounts. Then, control ends.

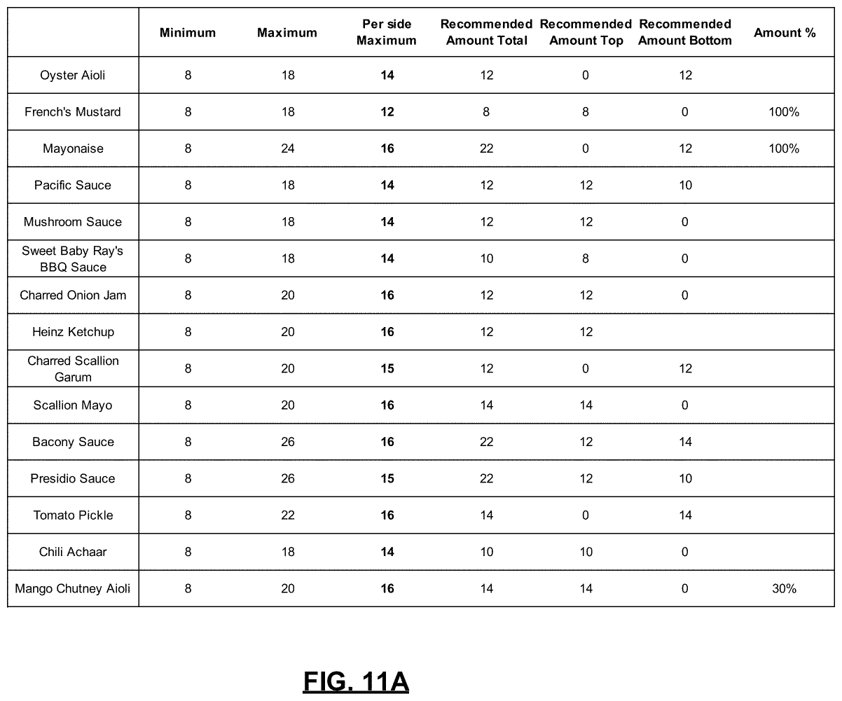

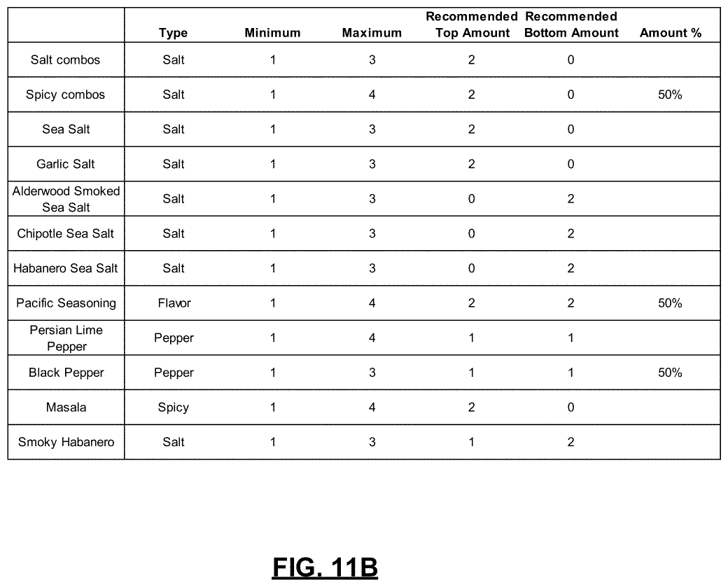

FIGS. 11A and 11B are tables including example condiment rules for a list of sauces and a list of seasonings. The tables include minimum and maximums for each condiment as well as recommended placements and amounts. In various implementations, the recommended amounts may be the default settings when the user opts to add the condiment. From the default, recommended settings, the user can adjust the slider to personalize as desired. Also included are recommended percentages of the condiment of the total amount of that type of condiment. For example, in FIG. 11B, the recommended percentage of the spicy combos is 50%, meaning that the recommended percentage of the spicy combos of the total amount of seasoning is 50%. FIG. 11A is in ml measurements and FIG. 11B is in dash measurements.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. The phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A system for controlling a culinary instrument, the system comprising:
a component data structure storing, for at least some of a plurality of culinary components, a culinary attribute;
a menu data structure storing, for each of a plurality of items, a set of constituent components;
an order interface module configured to receive (i) a selection of a selected item of the plurality of items by a user and (ii) a set of adjustments to the selected item specified by the user, wherein each element of the set of adjustments describes a modification of an amount of a corresponding one of the plurality of culinary components;
an order feedback module configured to:
according to a first set of rules, assess the set of adjustments based on the culinary attributes of the corresponding ones of the plurality of culinary components; and
in response to the assessment, selectively provide feedback to the user regarding limitations on the set of adjustments; and
a control transformation module configured to, in response to user approval of the selected item, use a second set of rules to transform the selected item and the set of adjustments into a set of instrument control instructions, wherein the set of instrument control instructions dictate specific amounts of the corresponding ones of the plurality of culinary components, and wherein the culinary instrument autonomously performs the set of instrument control instructions to craft the selected item for the user.

2. The system of claim 1 further comprising a communication module configured to transmit the instrument control instructions to the culinary instrument over a communications network.

3. The system of claim 1 wherein:
the culinary attribute is sodium level; and
the first set of rules includes a total sodium limit.

4. The system of claim 3 wherein the order feedback module is configured to, in response to the assessment indicating that the set of adjustments exceeds the total sodium limit, provide feedback to the user indicating a sodium concern and recommending a decrease in the set of adjustments.

5. The system of claim 3 wherein the order feedback module is configured to, in response to the assessment indicating that the set of adjustments exceeds the total sodium limit, reduce an amount of at least one of the set of adjustments.

6. The system of claim 3 wherein the order feedback module is configured to, in response to the assessment indicating that the set of adjustments exceeds the total sodium limit, proportionally reduce an amount of all of the set of adjustments whose corresponding sodium level is above a threshold.

7. The system of claim 1 wherein the first set of rules includes a limit on number of culinary components of a first type.

8. The system of claim 7 wherein the limit is determined based on a takt time of the culinary instrument.

9. The system of claim 1 wherein:
the component data structure stores, for at least some of the plurality of culinary components, a cost attribute; and
the first set of rules includes a cost limit.

10. The system of claim 1 wherein the first set of rules includes an upper limit on thickness-increasing culinary components.

11. The system of claim 10 wherein the upper limit is based on a vertical spacing between a dispensing subsystem of the culinary instrument and a conveyance subsystem of the culinary instrument.

12. The system of claim 1 wherein the order feedback module is configured to, in response to the assessment, selectively modify the set of adjustments to the selected item until the first set of rules is satisfied.

13. The system of claim 1 wherein the feedback comprises placing a restriction on extent of adjustment of user interface controls.

14. The system of claim 13 wherein the restriction includes preventing a slider control from moving to an end of its range.

15. The system of claim 1 wherein the feedback includes visually deemphasizing unavailable options.

16. The system of claim 15 wherein the unavailable options include currently unselected ones of the plurality of culinary components.

17. The system of claim 16 wherein:
the first set of rules includes an upper limit on number of unique liquid components; and
the order feedback module is configured to, in response to the upper limit being reached, visually deemphasize currently unselected liquid components.

18. The system of claim 1 wherein the first set of rules includes an upper limit on liquid volume.

19. The system of claim 1 wherein the first set of rules includes a plurality of upper limits on liquid volume for respective locations of a food item.

20. The system of claim 19 wherein the order feedback module is configured to, in response to any one of the plurality of upper limits being exceeded, redistribute liquid culinary components to other locations.

21. The system of claim 1 wherein the control transformation module is configured to determine the specific amounts by quantizing amounts specified by the user into increments dispensable by the culinary instrument.

22. The system of claim 1 wherein the second set of rules includes, for at least some of the plurality of culinary components, a minimum dispensed amount.

23. The system of claim 1 wherein the control transformation module is configured to specify an order of application of the corresponding ones of the plurality of culinary components.

24. The system of claim 1 wherein the control transformation module is configured to specify dispense target areas for the corresponding ones of the plurality of culinary components.
